(19) United States
(12) Patent Application Publication
(10) Pub. No.: US 2011/0114909 A1
(43) Pub. Date: May 19, 2011

(54) GUARD RAIL INCLUDING NOISE-REDUCING MEASURES

(76) Inventor: Thomas Willum Jensen, Vaerlose (DK)

(21) Appl. No.: 13/054,586

(22) PCT Filed: Jul. 2, 2009
(86) PCT No.: PCT/EP2009/058340

§ 371 Date: Jan. 18, 2011

(30) Foreign Application Priority Data
Aug. 12, 2008 (DK) PA 2008 01085

(51) Int. Cl. E01F 8/00; E01F 15/14; G10K 11/16

(52) U.S. Cl. 256/13.1; 181/210

(57) ABSTRACT

A guard rail is provided with noise-reducing measures and includes a plurality of substantially vertical posts supporting a longitudinal guard rail beam. Furthermore the guard rail is provided with plate-shaped noise-reducing modules attached to the supporting, substantially vertical posts. Advantageously, the guard rail may be perforated so that the sound is allowed to pass into the noise-reducing modules at the rear.

### TECHNICAL FIELD

The invention relates to a guard rail including noise-reducing measures and being according to the preamble of claim 1.

### BACKGROUND

A guard rail is a structure provided along a road section and with the object of limiting personal injuries by catching, slowing down or turning away vehicles veering off the roadway unintentionally. Guard rails can be categorized as road guard rails provided along a road usually on the verge (possibly on the centre strip), or as bridge guard rails mounted along the verge of a bridge or another structure. The guard rail may be a steel guard rail, the beam and the vertical posts of which are made from sectional steel.

Along busy roads in built-up areas it is furthermore commonly known to provide noise-reducing measures such as embankments, concrete walls or wall shaped structures for keeping down traffic noise. A guard rail according to the preamble to claim 1 is known from JP2007218084A, JP10338913A and EP1528158A1.

### DISCLOSURE OF THE INVENTION

The aspect of the invention is to provide a guard rail with noise-reducing measures and which can be manufactured as an attractive economic alternative to the known structures. To achieve this aspect the guard rail according to the invention is characterised by the characteristic features stated in claim 1.

The noise-reducing features of the structure are improved distinctively by the guard rail beam being perforated thus allowing the sound to pass into the noise-reducing modules provided at the rear and by the top plate reflecting the sound to the noise absorbent modules.

The embodiments of the guard rail appear from the sub claims.

By making use of the steel guard rail normally being placed along the verge of the road close to the roadway, the height of the plate-shaped noise-reducing modules may be lower than twice the height from the bed to the top of the guard rail beam—and often they may be of the same height as said guard rail beam. This is can be done as road noise arises from three sources:
1. Engine noise which is normally reduced by exhaust silencers;
2. Signal noise arising from hooters and the like; and
3. Tyre noise resulting from the contact between the tyre and the roadway.

As especially the last-mentioned source of noise creates a nuisance on long, straight road sections at normal, steady speed, the sound barrier may advantageously be provided close to the source of noise, and thus a considerable muffling can be achieved without scarring the surroundings with a tall wall. Furthermore, it is advantageous that a considerable part of the noise is spread along the ground level and thrown back hereby.

The plate-shaped noise-reducing modules may advantageously include a mineral wool plate sheathed with a stiff metal net.

The invention may advantageously be applied in connection with a double-sided guard rail including two substantially parallel and opposite oriented guard rail beams. Thus the noise-reducing modules are provided between the noise-reducing beams and absorb the sound energy in the immediate vicinity (preferably less than 4 metres) of the primary source of noise—the contact between the tyre and the roadway.

Furthermore the invention relates to a road system including at least one roadway, a guard rail according to any one of claims 1 to 9 being provided along said roadway.

By attaching the plate-shaped noise-reducing modules to the supporting, substantially vertical posts it is possible to absorb the noise energy in the immediate vicinity of the primary source of noise—the contact between the tyre and the roadway. The guard rail is provided along and in the immediate vicinity of the roadway, and in a preferred embodiment it is provided as a separation between two opposite oriented roadways.

### BRIEF DESCRIPTION OF THE DRAWING(S)

Below the invention is explained in detail in connection to preferred embodiments and with reference to the drawings, in which

FIG. 1 is a diagrammatic view of a preferred embodiment of a single-sided guard rail including noise-reducing elements according to the invention.

FIG. 2 shows a cross-section of the guard rail shown in FIG. 1 along the line A-A.

FIG. 3 shows a cross-section of the guard rail shown in FIG. 1 along the line B-B.

FIG. 4 is a diagrammatic view of a preferred embodiment of a double-sided guard rail with noise-reducing elements according to the invention.

FIG. 5 shows a cross-section of the guard rail shown in FIG. 1 along the line A-A.

FIG. 6 shows a cross-section of the guard rail shown in FIG. 1 along the line B-B.

FIG. 7 shows an alternative embodiment of the guard rail shown in FIG. 4 as a cross-section equal to FIG. 5.

FIG. 8 is a perspective view of an embodiment of a top plate for the guard rail shown in FIG. 7.

FIG. 9 shows a road system including both a single-sided and a double-sided guard rail according to the invention.

### DETAILED DESCRIPTION OF THE INVENTION

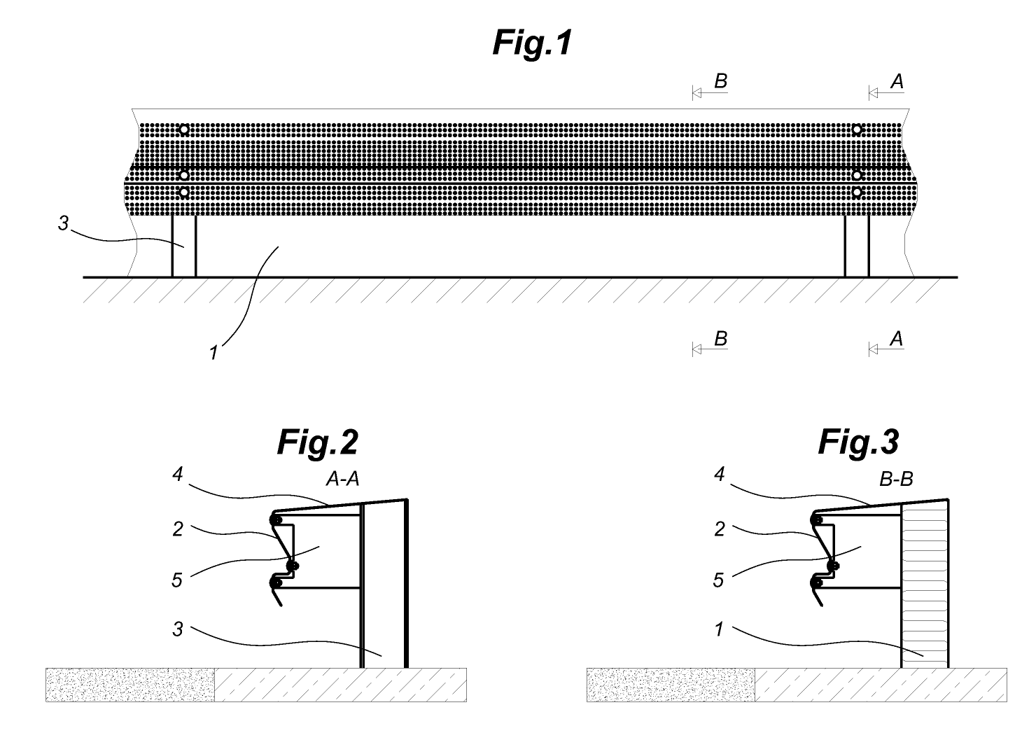

FIGS. 1-3 show a preferred embodiment of a single-sided guard rail including noise-reducing elements according to the invention. The guard rail is constructed as a steel guard rail including a plurality of posts 3 provided at a predetermined distance and supporting the guard rail, which is anchored into the ground, gravel or concrete. Advantageously, the posts 3 often may have an H-profile. It is not shown in the Figures, but conventionally the guard rail has a starting point and/or an ending point with a gradual adjustment of the height of the guard rail from its full height to zero—i.e. a decline in the guard rail. The invention is particularly applied at sections at full height.

Conventionally, a supporting arm 5 manufactured from steel and having a U-shape is attached to the posts 3, the extremities of said supporting arm 5 being secured with bolts or welded to one of the posts 3. A guard rail beam 2 is secured with bolts to the supporting arm 5. As a single-sided guard rail is constructed to work on collision solely from one side, a person skilled in the art can understand that securing the guard rail beams 2 ensures that they may be prolonged slightly and ensure that the guard rail is not broken through in case of an accident, the deformability of the supporting arms 5 absorbing the energy from a vehicle in case of a collision.

In the preferred embodiment the guard rail beam 2 is connected to a top plate 4. In another embodiment the guard rail beam 2 and the top plate 4 may be two separate sectional plates.

A noise-reducing plate 1 absorbing the noise from passing traffic is provided between, in front of or behind the posts 3.

Advantageously, the noise-reducing plate 1 may have a mineral wool core sheathed with a steel wire netting or a perforated plate—possibly with a metal frame along the edge; thus said metal frame may be used to fasten the plate 1 to the posts 3. In the preferred embodiment the plate 1 has a height fitting the height of the guard rail.

Alternatively, the plate 1 may be placed in front of the post 3 or behind the post 3. Alternatively, the plate 1 may have a core of polymer material.

In the preferred embodiment of the invention a considerable part of the guard rail beam 2 is provided with perforations—e.g. punched perforations having a diameter of 3 mm at a centre distance of 6 mm. Hereby the acoustic qualities of the beam ensure that the sound passes into the noise-reducing plate 1 at the rear instead of being reflected. Advantageously, the perforations may be punched before the plate is pressed to the final form of the guard rail beam 2.

Provided that the guard rail is placed far from the source of noise, it may in some connections be appropriate to heighten the posts 3, so that an additional noise-reducing plate 1 is fastened above the guard rail 2, the noise-reducing measure thus obtaining twice the height of the guard rail.

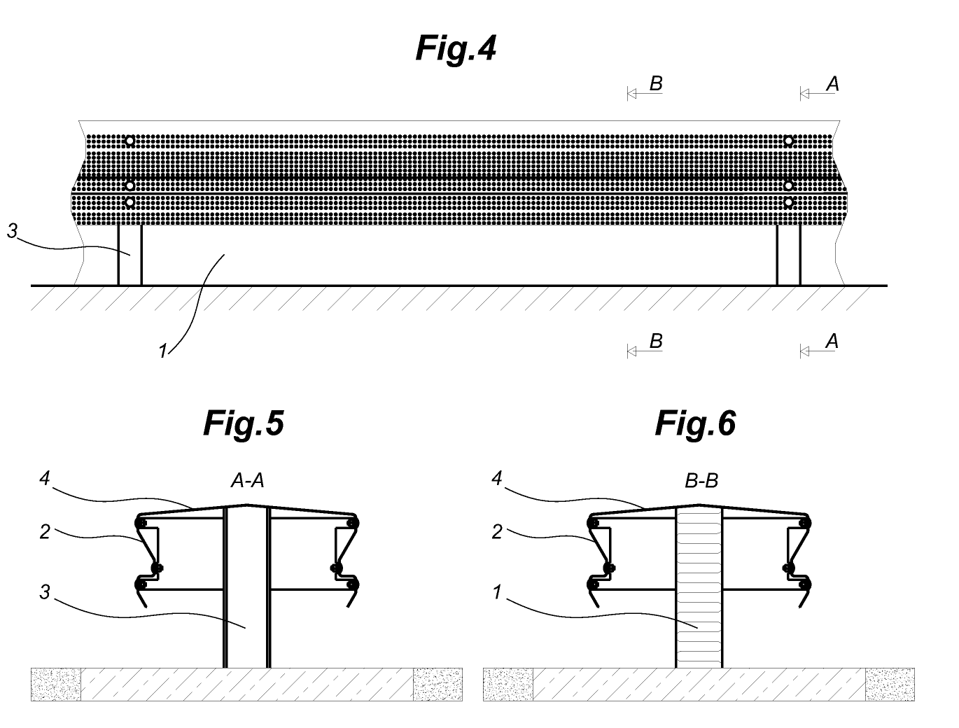

FIGS. 4-6 show a double-sided guard rail constructed to work in case of collisions from both sides. The functioning is the same as with the single-sided guard rail explained with reference to FIGS. 1-3., but said double-sided guard rail has two substantially parallel and opposite oriented guard rail beams 2 and noise-reducing plates 1 provided in between the guard rail beams 2.

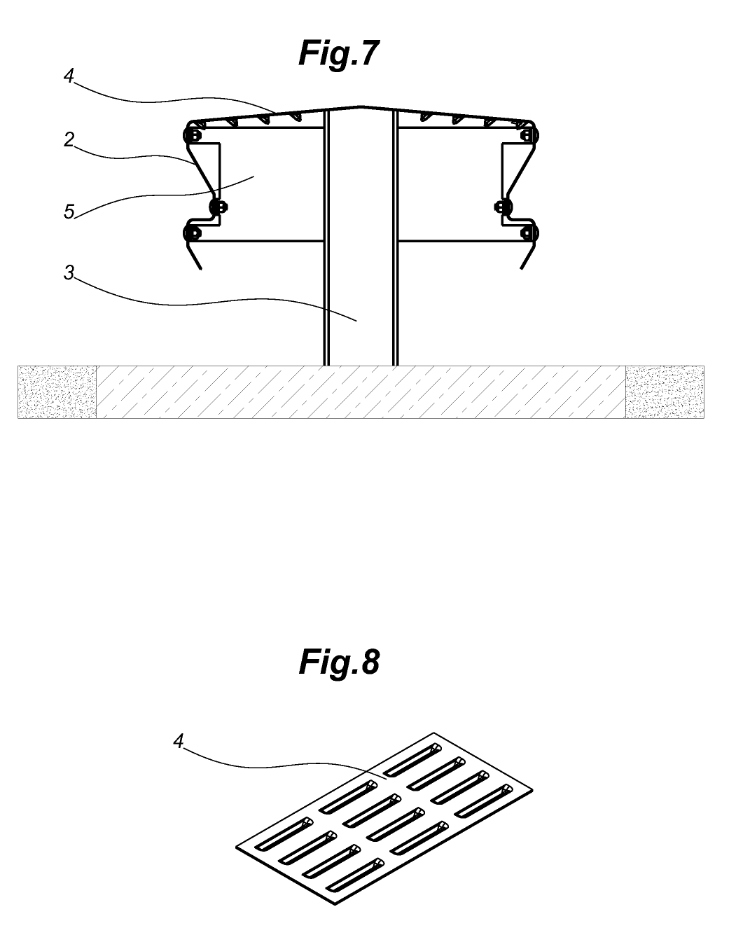

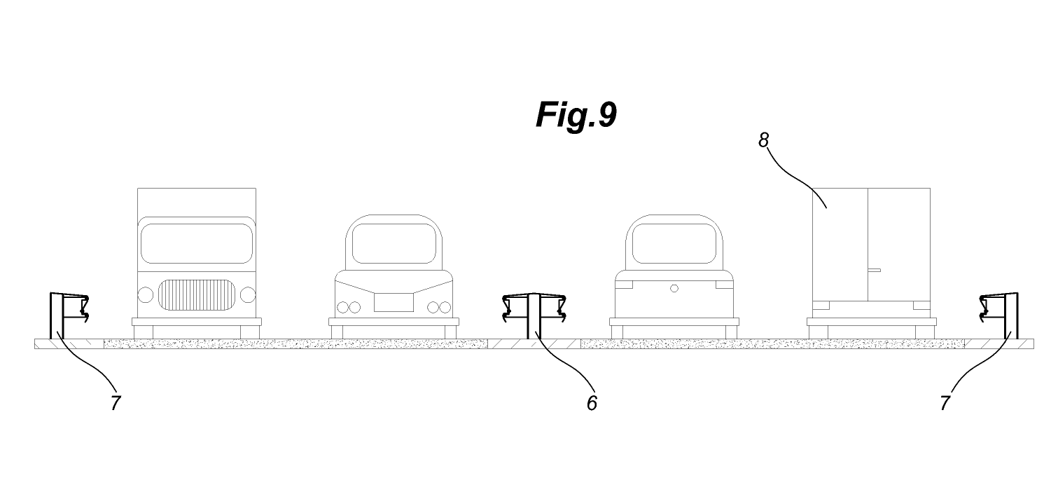

FIGS. 7 and 8 show an alternative embodiment having perforations in the top plate 4, the punched perforations being long so that the top plate substantially has the characteristics of a grating.

Thus the invention relates to a noise-reducing guard rail combining a wall 1 of noise absorbing material, a top plate 4 as well as a guard rail beam 2. The top plate 4 functions as a part of the guard rail and reflects noise which would escape between the noise wall 1 and the guard rail beam 2, if said top plate 4 was not provided. The noise is reflected back to the noise absorbing wall 1.

The invention may be applied along all known roadways along which a guard rail is desirable or required. Furthermore, the noise-reducing guard rail functions as a traditional guard rail and shall also reduce traffic noise. The top plate may have a noise-reducing material at the underside. The guard rail beam may be reinforced by longitudinal steel wires.

FIG. 9 shows a roadway with two lanes in each direction. Along the roadside single-sided guard rails 7 are provided of the kind explained with reference to FIGS. 1-3, and the opposite oriented lanes are separated by a centre strip along which a double-sided guard rail 6 is provided of the kind explained with reference to FIGS. 4-6. Hereby the noise from traffic 8 at large approach roads may be reduced substantially without a town being intersected by an unsightly barrier.

1-10. (canceled)

11. A guard rail having noise-reducing measures and including a plurality of substantially vertical posts (3) supporting a longitudinal guard rail beam (2), plate-shaped noise-reducing modules (1) being attached to the supporting, substantially vertical posts (3), characterised in that the guard rail beam (2) is perforated thus allowing the sound to pass into the noise-reducing modules (1) at the rear, a considerable part of the guard rail beam (2) being provided with perforations so that the acoustic qualities of the beam ensure that the sound passes into the noise-reducing modules at the rear instead of being reflected and in that the guard rail further includes a top plate (4) reflecting noise, which without said top plate (4) would escape between the noise-reducing modules and the guard rail beam (2), back to the noise-reducing modules (1).

12. A guard rail according to claim 11, the height of the plate-shaped noise-reducing modules (1) being less than twice the height from the bed to the top of the guard rail beam (2).

13. A guard rail according to claim 11, the plate-shaped noise-reducing modules (1) including a mineral wool plate (or a different noise-reducing material) sheathed with a stiff metal net.

14. A guard rail according to claim 11, the guard rail beam (2) being connected to the top plate (4).

15. A guard rail according to claims 11, the guard rail beam (2) and the top plate (4) being two separate sectional plates.

16. A guard rail according to claim 11, whereby the perforations of the guard rail beam (2) are punched perforations punched in a plate prior to said plate being pressed into the final form of the guard rail beam (2).

17. A guard rail according to claim 11, whereby the top plate (4) is provided with perforations in the form of punched long perforations so that the top plate substantially has the characteristics of a grating.

18. A guard rail according to claim 11, whereby the top plate (4) is provided with a noise-reducing material at the underside.

19. A guard rail according to any of the claim 11, whereby said guard rail is double-sided having two substantially parallel and opposite oriented guard rail beams (2) with noise-reducing modules (1) provided in between.

20. A road system having at least one roadway including at least one guard rail according to claim 11, said at least one guard rail being provided along and in the immediate proximity of the roadway.
